(19) United States
(12) Patent Application Publication
(10) Pub. No.: US 2016/0204933 A1
(43) Pub. Date: Jul. 14, 2016

(54) PERSONAL INFORMATION MANAGEMENT SYSTEM, METHOD AND SERVICE

(71) Applicants: Corrado Ronchi, Roma (IT); Shukhrat Zakhidov, Tashkent (UZ)

(72) Inventors: Corrado Ronchi, Roma (IT); Shukhrat Zakhidov, Tashkent (UZ)

(21) Appl. No.: 14/996,105

(22) Filed: Jan. 14, 2016

Related U.S. Application Data
(60) Provisional application No. 62/103,317, filed on Jan. 14, 2015.

(51) Int. Cl. H04L 9/08; H04W 12/04

(52) U.S. Cl. CPC H04L 9/08; H04W 12/04

(57) ABSTRACT

A system and corresponding method for protecting the privacy associated with one or more encrypted data records includes a host device and a security device. The host device is operable to allow access to the one or more data records being in an encrypted format including encrypted data records, and upon an attempt to access the one or more encrypted data records transmitting a request for an encryption key for unencrypting the encrypted data records to a security device. The security device is remote from the host device and is operable to require one or more actions being taken by a user as a condition to providing the encryption key, and upon the success of the actions as the condition, transmitting the encryption key to the host device. The host can then unlock the encrypted data records upon receipt of the encryption key. In different implementations, either the encrypted data records can be resident on the host device, or there can be fields associated with each of the encrypted data records maintained on the host device, and the encrypted data records associated with them can be resident on the security device. Further included is a remote processing device such as a server accessible over the Internet, the remote processing device able to access the encryption key, to require one or more items of information provided by a user as a condition to providing the encryption key, and upon determining the items to be correct, transmitting the encryption key to the host device.

### PRIORITY INFORMATION

The present application claims priority under 35 U.S.C. §119(e) to U.S. Provisional Patent Application Ser. No. 62/103,317, filed Jan. 14, 2015, the entire contents of which are expressly incorporated herein by reference.

### TECHNICAL FIELD

The present embodiments relate to a method and service for protecting and managing personal digital information across multiple computing and storage platforms. More particularly, the present embodiments provide a method and service for storing sensitive and personal data on a hardware device.

### BACKGROUND

The following definitions and explanations are intended to facilitate the understanding of the present embodiments without limiting their scope. A problem of securely storing and managing personal and private information today requires the users of personal computers and smart phones to install and run special purpose client applications specifically designed for such task. Exemplary programs are software products known as password managers, such as Lastpass, Dashlane, Roboform, 1Password, to name just a few. The operation of these commercial products typically requires users to authenticate themselves before they are granted access to information, data or services which are either financially relevant or confidential in nature. In other words, these products operate on the assumption that users can be effectively and securely authenticated before access to the stored data is provided to them.

The most common, simple and convenient form of authentication is based on the use of a static (i.e. fixed in time) credential (e.g. a password) which the user must provide to the application each time it is executed. In such scenario, the security of all the stored data relies totally on the secrecy of the authentication credential which is the only factor guarding against illegitimate usage by unauthorized individuals. The need to remember only one password to access all the data stored by password managers and the pivotal role this requirement plays in securing the private data is aptly highlighted by the customary appellation of a master password. One main argument in favor of using password managers requiring one single static master password is clearly the convenience, whereby the user can access all of his passwords anytime and anywhere as long as he remembers just one single secret credential.

The use of client password managers alone cannot, however, satisfy one prime requirement of users who wish to access their passwords on a number of separate devices which they typically access at different times during the day. This is the case, for example, of a laptop and smart phone which can be both used to access online banking services. The same password will be needed on both platforms where it can also be updated if required by the service provider or desired by the user. This example highlights the need to share and synchronize the passwords database across all devices accessed by the user, a task which clearly cannot be performed by independent instances of an installed client application running on separate disconnected platforms.

This latter consideration has prompted vendors of software password managers to develop and deploy cloud-based services designed to support the synchronization requirements of users. Typically, such service requires the payment of a yearly fee and the servers store and fetch from the cloud the latest password database previously copied in encrypted format over Internet from any of the installed database instances of the client application. When properly implemented by the vendors, this method can allow satisfying both the synchronization requirement as well as the need to provide an updated backup of the latest password database which can later be used for recovery purposes.

The picture that emerges from the above description of the typical way that software password managers operate can be summarized as follows. Users can install the client application on any of their digital platforms (laptop, PC, smart phone, etc.) and rest assured that by remembering only the master password they will be granted access to the latest version of the password database as long as they are connected to the Internet.

It is worthwhile to rephrase the above value proposition by highlighting the critical enabling underlying factors. While employing software password managers, users must: (1) rely on the confidentiality of the Master Password as the sole protection against unauthorized disclosure of all the contents of the password database. In other words, an attacker capable of sniffing or obtaining in other fraudulent way the master password can in principle and in practice gain access to all other passwords kept in the password database; (2) trust the product vendor and cloud service provider with the entire contents of the password database, albeit in encrypted format. In other words, notwithstanding all of the provided assurances, the user must accept to release his most valuable data to a third party in the hope that it will be securely handled according to all the agreed and implied policies and procedures; and (3) accept the limitation of synchronizing the password database across his computing platforms only when accessing Internet (i.e. while operating online). This requirement is at the root of the cloud as a service-for-fee and in some products (e.g. LastPass) it is also extended to the case of one password database on a single platform (i.e. passwords are all stored on the cloud and cannot be accessed offline).

The above three tenets of mainstream software password managers' usage, namely rely, trust, accept, pose serious questions regarding the practical security and suitability of such products in today's real-life digital information management scenarios. In fact, the use of a static master password has been shown to be ineffective against social engineering, brute force guessing and malware driven attacks whereby a third party is capable of obtaining the password for reading any amount of the private stored data before the legitimate user discovers the theft. Such attacks highlight the main weakness of static login credentials, i.e., the decoupling of the authentication credentials from the individual which they are purposing to authenticate. In this case, the simple knowledge of the password allows any individual to enjoy the authenticated status. In the case of password managers the threat can be even more effective than against web services which can stop providing the service when under attack. In fact, once an attacker copies the local password database he can perform brute force rounds to discover the Master Password (or equivalent secret) without any limitation on the number of attempts.

The use of static login credentials for applications requiring strong security assurances such as password managers has, therefore, been strongly criticized by security professionals warning about the catastrophic consequences of a theft or an unauthorized disclosure of the master password.

Indeed, having realized that this problem risks undermining the very foundations of their products' value proposition, vendors of software password managers have started advocating the adoption of small hardware devices as additional authentication means beyond the simple and sole master password.

The more general class of two-factor authentication methods which aim at binding the presence of the physical user to the requirements of the authorization procedure. The second factor in addition to the static credentials can be something that the user has (a physical device or a token external to the host device) or something that the user is (obtained using biometric sensors, e.g. via fingerprinting or iris scanning). Because of limitations due to the technology and to the still relatively high costs associated to mass deployments of biometric devices, the prevailing choice has until now been to provide users with small hardware tokens which the user must have and operate each time he requests access to the password database and cloud service.

However, both the static master password and the two-factor authentication methods described above suffer from one fundamental weakness, i.e., the need to rely on an application (a software controlled process executed on the host device) to authorize the user and communicate with the cloud sever.

For example, the application executing on the host device may require to retrieve a password, in which case the cloud sever may generate a random session key, and then protect the session key in such a way that it can be obtained only with the user-specific secret key kept in the hardware device owned by the user. With this approach, it would seem that no one except the legitimate user could receive the data, since only the password manager application can access the secret key and the secret key can never leave the device safely kept and operated by the user.

However, this approach has a weakness in that a rogue application, developed by a malicious programmer and executed on the user's host device—or on the programmer's device through remote connection—can make an identical request to the cloud server after obtaining all the necessary authentication data from the unaware user. In fact, the objective of the rogue application is only to access the sensitive cloud resources and not to know or extract the user-specific secret key from the hardware device. To obtain its goal, the rogue application can simply make the same authentication request to the cloud server that the client application would do using the user-specific secret, and thus obtain access to the sensitive data on the server. In this example, there is nothing to differentiate from the cloud server point of view the password manager's authentication request from that of the rogue application. Once this latter has gained access to the service, it can in principle operate independently from the legitimate application and from any further user input.

Remarkably, the weakness described above applies to all user-based authentication methods, regardless of the enabling technology applied to generate and store the secret access credentials. In fact, the roots of this vulnerability rest in the need for all user-based authentication methods to rely on the trustworthiness of the applications employed to communicate with the cloud service providers.

It is therefore clear that the security of cloud-enabled transactions is first and foremost dependent on the ability to authenticate executable code running on a host device, an issue which falls into the more general category of software security. The goal of providing reliable and practicable means for remotely authenticating software applications has been the subject of U.S. Pat. No. 8,713,705B2 and will not be further discussed here. Suffices to conclude, however, that the approach advocated by vendors of software password managers cannot claim to resolve in any definitive way the critical vulnerability tied to the user's authentication and authorization when employing a static Master Password, with or without additional “strong” authentication means.

The criticality mentioned above is clearly related to the catastrophic nature of the security failure which occurs once the authentication and authorization steps are bypassed by a malicious code or attacker, namely the exposure of the entire contents of the password database. Hence, it is highly desirable to improve prior art methods for authorizing access to private information and data, and to also remove the requirements and limitations imposed on the users of software password managers (rely, trust, and accept).

### SUMMARY

An object of the embodiments is to substantially solve all the problems and/or disadvantages discussed above, and to provide at least one or more of the advantages described below.

It is therefore a general aspect of the embodiments to provide systems, methods, and modes in accordance with the following. In particular, a system for protecting the privacy associated with one or more encrypted data records includes: a host device operable to allow access to the one or more data records being in an encrypted format including encrypted data records, and upon an attempt to access the one or more encrypted data records transmitting a request for an encryption key for unencrypting the encrypted data records to a security device; and a security device remote from the host device operable to require one or more actions being taken by a user as a condition to providing said encryption key, and upon the success of said actions as said condition, transmitting said encryption key to the host device.

The host device can unlock the one or more encrypted data records upon receipt of the encryption key. The one or more encrypted data records can be resident on the host device. In addition, the one or more fields associated with each of the one or more encrypted data records can also be maintained on the host device, and the one or more encrypted data records associated therewith can be resident on the security device.

The host device and security device may be securely coupled over a telecommunications connection, with the connection being any one of a wireline and a wireless connection. The security device may be a system closed from external communications but in relation to the encrypted data records and one or more additional encrypted data records, and further may be operable to execute low level instructions in an embedded, secured processing system. The host device may include one or more software applications resident and executing on any one of: a personal computer; a tablet; a smart watch and a mobile communications device. The one or more aforementioned actions may be any one of: physical actuation by a user; entry of information by the user; and entry of biometric information by the user.

The system may further include a remote processing device accessible over the Internet, the remote processing device (a) able to access the encryption key, (b) being operable to require one or more items of information provided by a user as a condition to providing the encryption key, and (c) upon determining the items of information to be correct information, transmitting the encryption key to the host device.

The system may also include any one of: an out-of-band authentication of a user; and a dynamic authentication of a user upon the processing of one or more signals between the host device and the security device. The host device may be further operable to maintain the encryption key and to mark the encrypted data records to reflect that the encryption key is being maintained on the host device.

Also provided is a method for protecting the privacy associated with one or more encrypted data records accessible by a host device, with the method including: maintaining an encryption key for unencrypting the one or more records on a security device; upon an attempt to access the one or more encrypted records, transmitting a request for the encryption key to the security device; and requiring one or more actions to be taken in relation to the security device as a condition to providing the encryption key to the host device. The method can further include: unlocking the one or more encrypted records of the host device upon receipt of the encryption key.

The one or more encrypted data records may be maintained resident on the host device. Also, one or more fields associated with each of the one or more records can be maintained on the host device, and the one or more encrypted data records can be maintained resident on the security device. The method further includes securely coupling over a telecommunications connection the host device and security device, with the connection being any one of a wireline and a wireless connection. Also, low level instructions may be executed in an embedded, secured processing system on the security device. Also, the encryption key may be maintained on a remote processing device accessible over the Internet, and upon an attempt to access the one or more encrypted records, the method may require one or more items of information being provided by a user as a condition to providing the encryption key from the remote processing device.

Further, the above noted one or more actions may include any one of: physical actuation by a user; entry of information by the user; and entry of biometric information by the user. The method may further include any one of: an out-of-band authentication of a user; and a dynamic authentication of a user upon the processing of one or more signals between the host device and the security device.

Additionally is provided a method for protecting the privacy associated with one or more encrypted data records accessible, the method including: maintaining the encrypted data records resident on a device, the encrypted data records being operable to become unencrypted upon actuation of a unique encryption key; upon an attempt to access the one or more encrypted records, transmitting a request for the encryption key; and upon user action being taken remotely, actuating a received key comprising the unique encryption key to unencrypt the encrypted data records.

Furthermore, a method is provided for protecting the privacy associated with one or more encrypted data records accessible, the method including: maintaining a unique encryption key operable to unlock one or more encrypted data records, said encrypted data records being remote from a device; and upon actuation by a user, transmitting the encryption key to the remote device in order to permit unlocking of said one or more data records.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified.

FIG. 1 illustrates a high level block diagram of a system for managing personal information according to aspects of the embodiments.

FIG. 2 illustrates the high level block diagram of FIG. 1 further illustrating a number of differing exemplary systems/devices that are used as a host according to aspects of the embodiments.

FIG. 3 illustrates the high level block diagram of FIG. 1 further illustrating a number of differing exemplary systems/devices that are used as a cloud server environment according to aspects of the embodiments.

FIG. 4 illustrates exemplary embodiments of a hardware security device according to aspects of the embodiments.

FIG. 5 illustrates a first embodiment of an exemplary host device including an application capable of executing operating system resources and memory locations storing information according to aspects of the embodiments.

FIG. 6 illustrates a second embodiment of an exemplary host device including an application capable of executing operating system resources and memory locations partitioned into unboxed and boxed records of stored information according to aspects of the embodiments.

FIG. 7 illustrates an exemplary hardware (“security”) device including an application capable of executing instructions and associated memory locations of the same in accordance with aspects of the embodiments.

FIG. 8 illustrates an exemplary remote system including one or more resources running remote applications and memory locations pertaining to the same, together comprising components of an exemplary Internet cloud according to aspects of the embodiments.

FIG. 9 illustrates the block diagram of FIG. 1 further illustrating an exemplary host, an exemplary security device and an exemplary Internet cloud with the greater detail associated with FIGS. 4-8 respectively, in accordance with certain aspects of the embodiments.

FIG. 10 illustrates a block diagram of a system high level architecture in accordance with certain aspects of the embodiments.

### DETAILED DESCRIPTION

### I. Overview

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments can, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

The following embodiments are discussed, for simplicity, with regard to the terminology and structure of the apparatus and methods employed. However, the embodiments are not limited to the foregoing.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics can be combined in any suitable manner in one or more embodiments.

In exemplary embodiments, a secure and flexible method and service is provided for authorizing and managing personal information on any number of client devices. It allows removing the requirements and limitations imposed on the users of software password managers (rely, trust, and accept) and overcomes all major drawbacks of known devices inasmuch the user is now always in control of his most sensitive data, but can still access them under all operational conditions.

Furthermore, it is practically impossible for a malicious programmer or malware code to steal all the personal information at once even when using a previously sniffed password required by the device or the server validation before each new request for access by the application.

These embodiments can be applied to three atomic operational conditions: (1) disconnected, meaning that the software password manager application is executed on a host without connection to a security device; (2) connected, meaning that the software password manager application is executed on the host while connected with a hardware device (e.g. over Bluetooth, USB, or other direct means), and (3) online, meaning that the software password manager application is executed on the host while able to communicate with a remote escrow service over Internet. Exemplary embodiments are set forth in greater detail below.

While there are numerous embodiments that enable authentication and personal information management in the described configurations and architecture, it is however expected that one with ordinary skill in the art will be capable of extending the concepts and principles disclosed herein to alternative embodiments by replacing the host, hardware device and/or the remote components with different or additional components capable of executing similar tasks. Examples of such alternative embodiments include the case in which the hardware and remote components are exchanged (i.e., the device authenticates the software application) and the case in which the remote system or the host or both are replaced by a mobile or tamper-proof secure device.

Additional aspects, advantages and novel features of the invention will be set forth in the description that follows and, in part, will become apparent to those skilled in the art upon examining or practicing the invention. The aspects and advantages of the invention may be realized and obtained by means of the instrumentalities and combinations particularly pointed out in the appended claims.

### II. Overall Environment

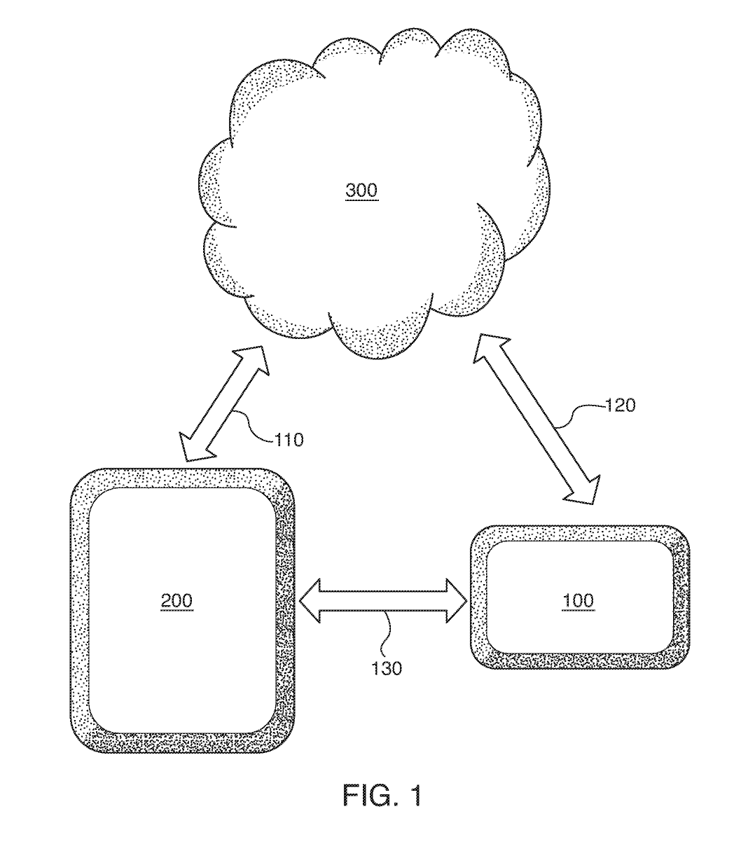

FIG. 1 portrays an exemplary overall environment in which a method and service for managing personal information data using a software application executing on a host computer connected to a hardware device and capable of exchanging data over Internet with a computing service according to the present invention may be used.

In reference to FIG. 1, an aspect of the present embodiments provides methods of distributing a password database information among up to three storage and computing systems: (1) the first, a host 200 runs a software password manager application, while (2) the second, a hardware device or “security” device 100, and (3) the third, a remote system, for example running on the Internet cloud 300, respectively provide additional security, data storage and authorization functions. As shown, exemplary host 200 and security device 100 are coupled 130 for communications, exemplary host 200 and cloud 300 are coupled 110 for communications, and cloud 300 and security device 100 are coupled 120 through host 200 for communications respectively between them.

In one embodiment, the password manager application, a software controlled process executed on the host device 200, is installed and run on one or more of the computing devices operated and owned by the user (PC, laptop, tablet, smart phone, etc.) and capable of connecting to the Internet. The user is also provided with security device 100 capable of storing and computing data, as well as of visualizing information and logging user confirmation via physical action (e.g., by pressing a button, swiping a finger, etc.) or entering a password via a keypad. For example, the user may be required to validate security-critical operations or requests, such as authentication and authorization procedures by pressing a button on device 100. In this exemplary embodiment, the personal information is stored in certain logically but not necessarily physically distinct databases as described below.

### III. Exemplary Host Device Systems

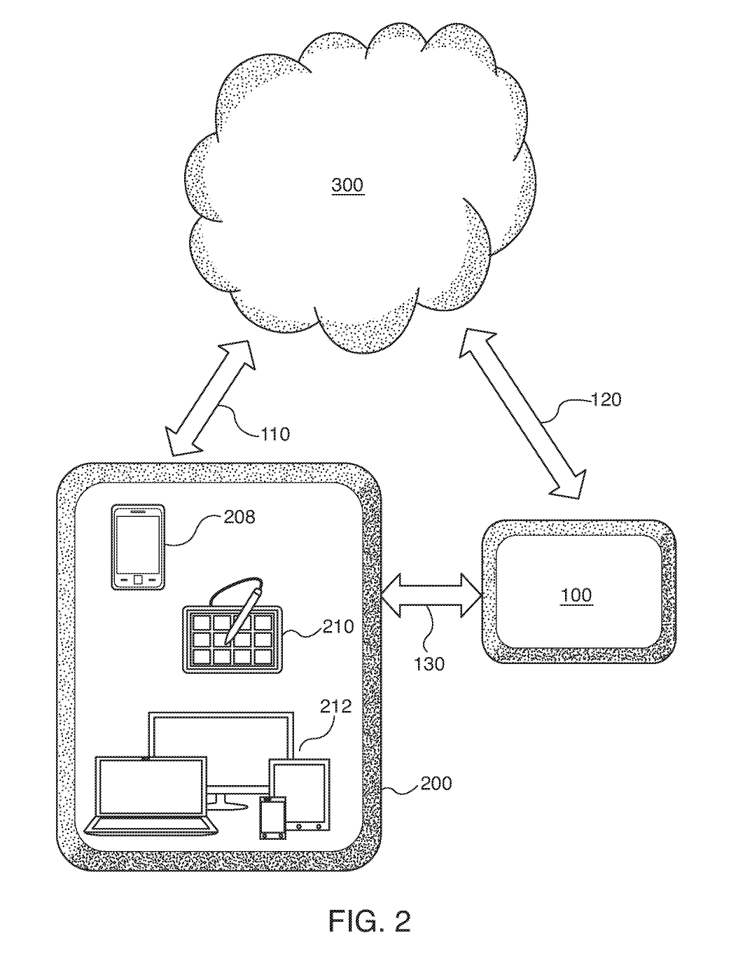

FIG. 2 is the same as FIG. 1 except that it illustrates a number of differing exemplary systems/devices that are used as host device 200. Specifically, mobile device 208, tablet 210 and a plurality of computers, tablets and servers connected over a LAN or WAN architecture 212 are shown, though any combination of hardware executing resident or non-resident software is capable of being used in accordance with the embodiments.

### IV. Exemplary Remote Cloud Server Systems

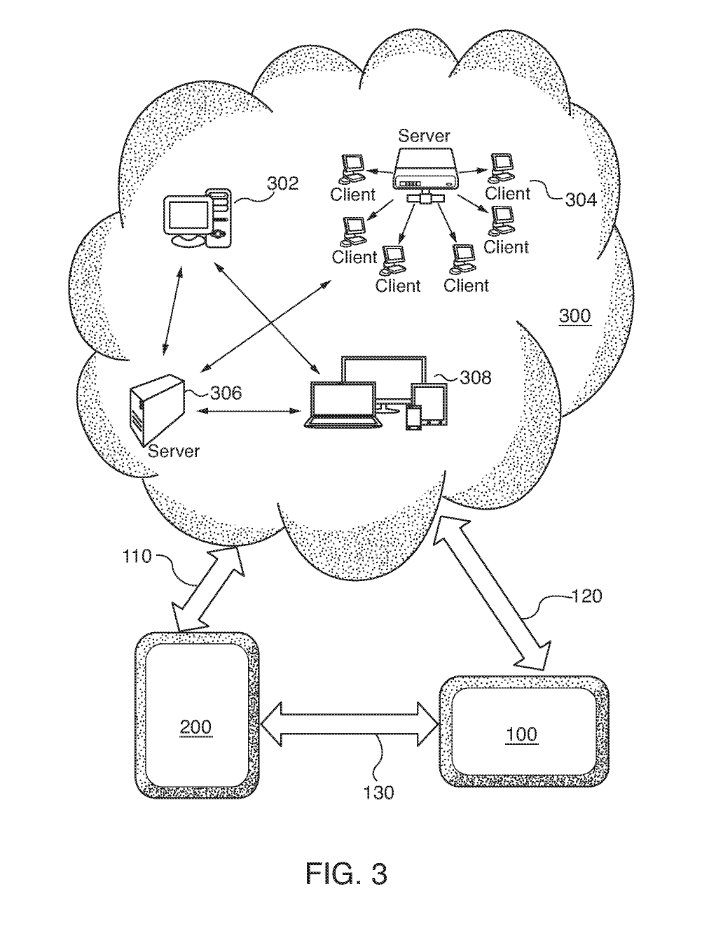

FIG. 3 is the same as FIG. 1 except that it illustrates a number of differing exemplary systems/devices that are used as a remote system comprising Internet cloud 300. Specifically, near remote server 302, distant remote server 306, a server/client environment (connected over a LAN) 304, and a plurality of computers, tablets and servers connected over a LAN or WAN architecture 308 are shown, though any combination of hardware executing resident or non-resident software is capable of being used in accordance with the embodiments.

### V. Exemplary Security Device Systems

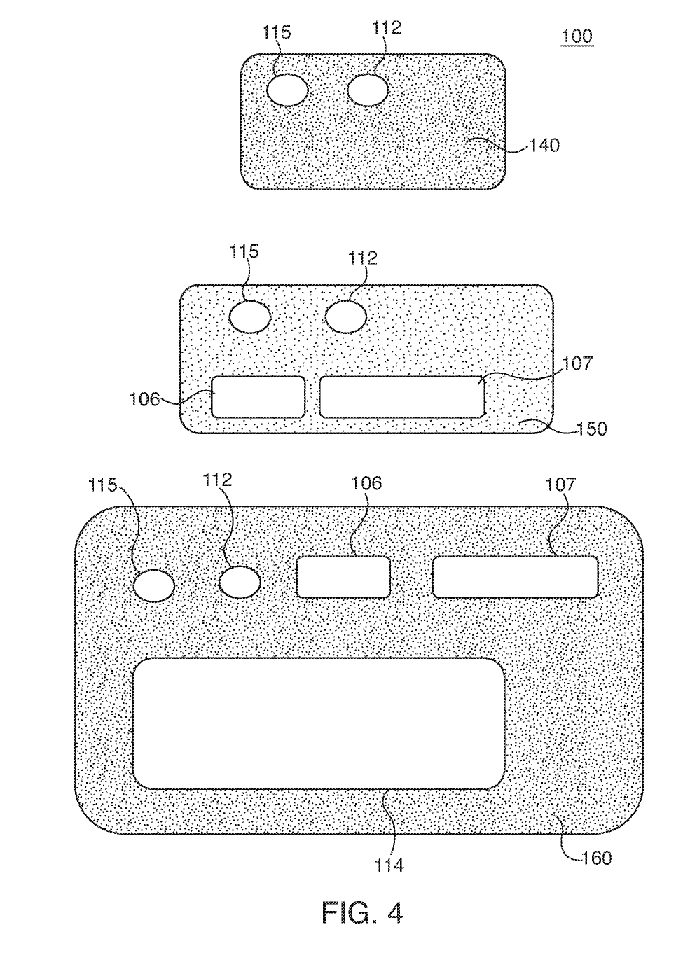

FIG. 4 illustrates exemplary embodiments of hardware device 100, namely exemplary devices 140, 150 and 160. Exemplary hardware device 140 includes an exemplary actuator device 115 and an output indication device 112, which can comprise an indicator light. Actuator device 115 is any resident or non-resident component that is physically actuated on the device. In an exemplary embodiment, actuator device 115 is a button which is depressed, serving as an input to the processor of device 140. Output indication device 112 may be, for example, an indicator light serving as output from the processor of device 140 to provide information to the user, such as that the user's actuation of actuator device 115 has been recognized or accepted.

Exemplary hardware device 150 includes the foregoing exemplary actuator device 115 and indicator light 112, and further includes expanded display module 107 and expanded input module 106. Display module 107 provides additional input to the user further to a light signal. Expanded input module 106 is adapted to receive input from the user including without limitation biometric input, voice input and other user-associated input which are recognized by the processor of device 150.

Exemplary hardware device 160 includes the foregoing exemplary actuator device 115, indicator light 112, expanded display module 107 and expanded input module 106. Device 160 further includes a full keyboard for user generated input.

### VI. Exemplary Implementation of Host Device Systems

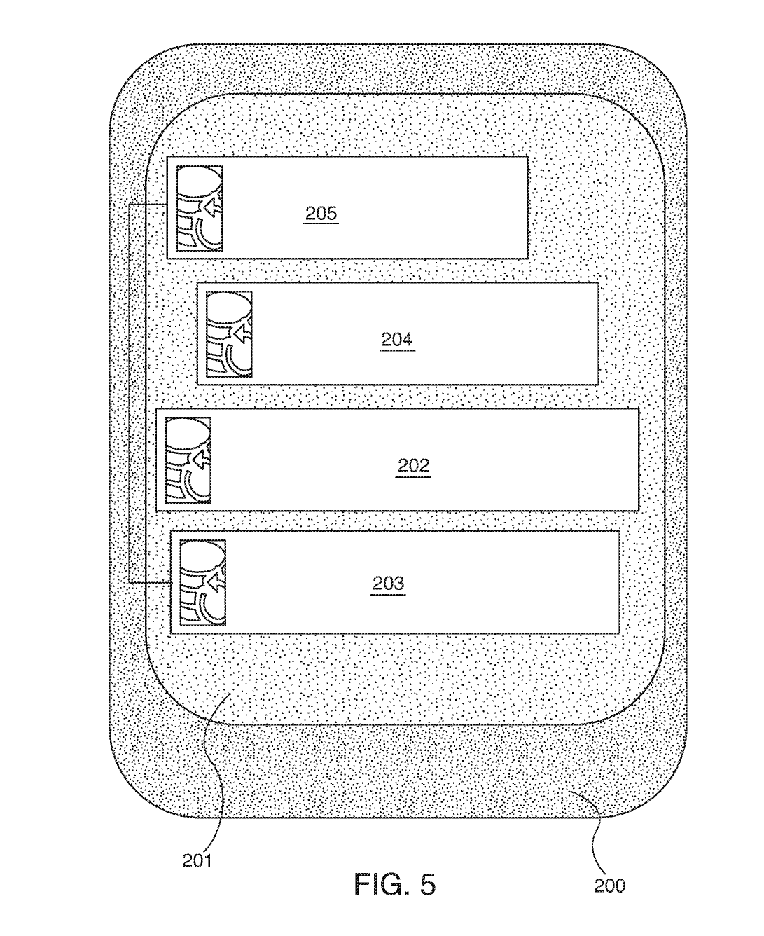

In reference to FIG. 5, host device 200 (e.g. PC, smart phone, tablet or other personal computing device) comprises a client application 201, such as for example software programming code or a computer program product. Client application 201 can be a software password manager. In the exemplary embodiment, client application 201 is embedded within, or installed on, the host device 200, where it can be executed within the operating system's context comprising all the resources and objects that are required for the execution of the client application 201 on the host device 200.

Such resources and objects include the ability to enter, store, retrieve, view, change, receive and transmit personal information data to/from hardware security device 100 and to/from processors running remotely in cloud 300. All of these devices are coupled or linked together over wired or wireless connections 110 in any fashion characterized and enabled by specific middleware, topology, protocol, and architecture providing the desired security and performance assurances.

FIG. 5 also illustrates host 200 in greater detail, including in addition to application 201, locations 202-205 where either data or pointers associated with memory locations are stored. In the illustrated embodiment, according to predefined constraints, required usage or individual preferences, the personal information data entered by the user of the system via client application 201 is stored on the host in data collections (e.g., in relational databases) 202-205.

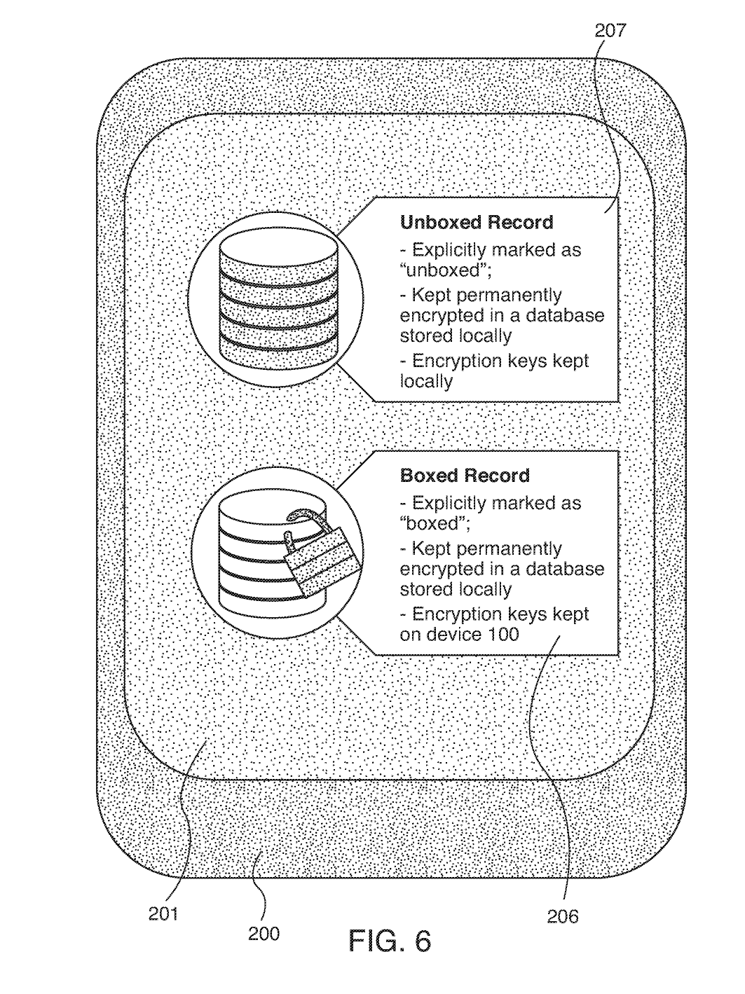

FIG. 6 illustrates an alternative implementation where the memory locations are partitioned for the type of data held and marked accordingly. The implementation is further described below.

### VII. Exemplary Implementation of Security Device Systems

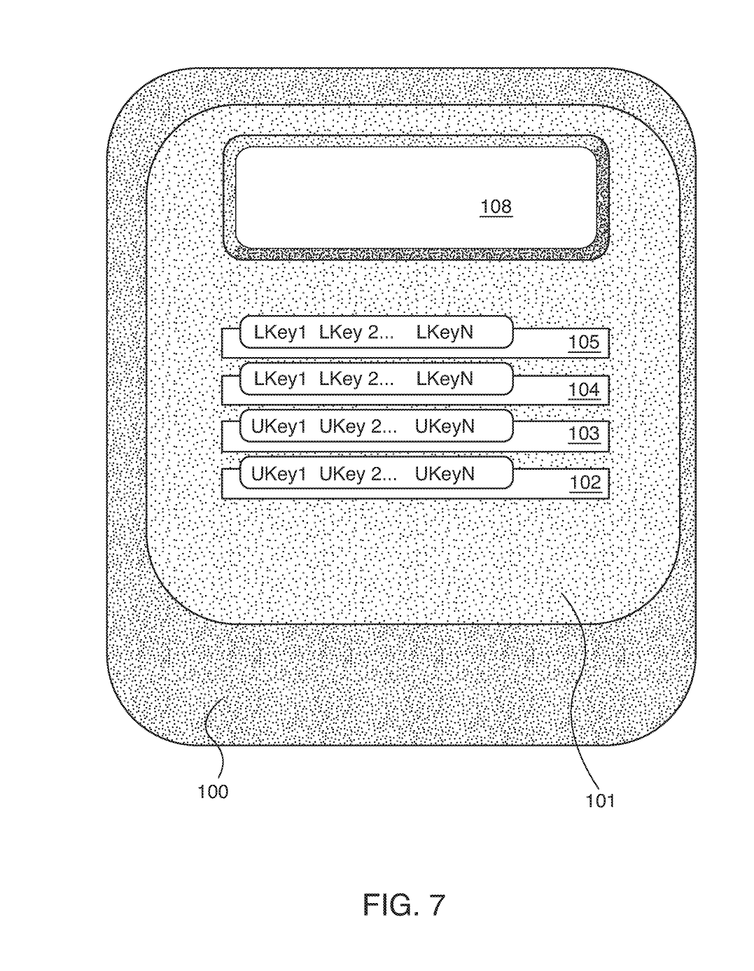

FIG. 7 an exemplary embodiment of the memory associated with security device 100. In particular, FIG. 7 illustrates the storage components 102-108 of device 100 in greater detail. Personal information data transmitted from host 200 to hardware device 100 over link 130 is stored in data collections 102-108, after operating on them by executing persistent memory and program code 101 (e.g., firmware). In exemplary embodiments, data collection 108 stores encrypted data, while data collections 102-105 are used for storage of encryption keys as hereinafter described.

### VIII. Exemplary Implementation of Remote Cloud Server Systems

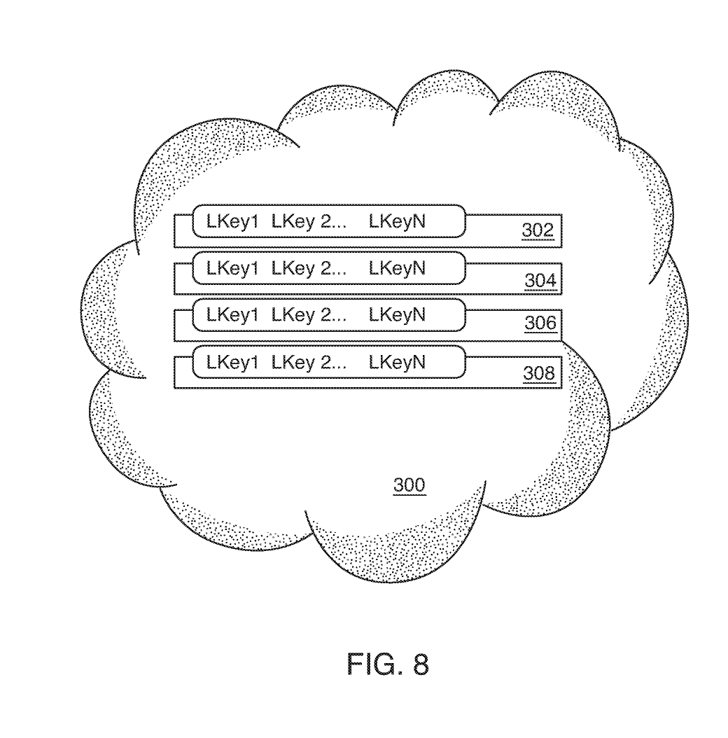

FIG. 8 is an exemplary embodiment of the memory associated with a remote server system running its own operating system and being remotely accessible over one or more telecommunications connections comprising Internet cloud 300. In exemplary embodiments, data collections 302-308 store encryption keys associated with one or more data records resident on either host device 200 or security device 100. In exemplary embodiments, the remote server in cloud 300 can also store and access encrypted data in memory locations (not shown).

### IX. Exemplary Implementation of Host Device, Security Device and Cloud Server Systems

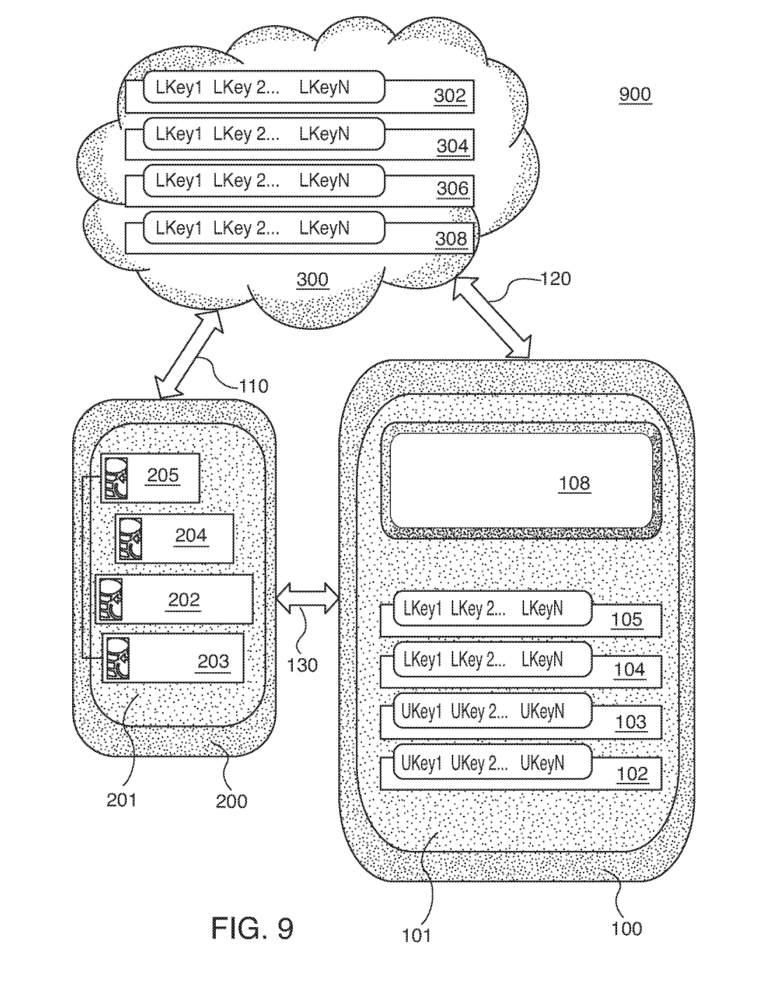

FIG. 9 illustrates the exemplary host device 200 of FIGS. 5, 6, the exemplary security device 100 of FIG. 7, and the exemplary remote server system of cloud 300 of FIG. 8. As shown, host device 200 and cloud 300 are coupled by connection 110; host device 200 and device 100 are coupled by connection 130; cloud 300 and device 100 are coupled by connection 120.

In an exemplary embodiment, data contained within database 203 is stored on host 200 running password manager software 201. Database 203 is kept permanently encrypted while the application is executed, but the database records and their keys can be accessed and individually decrypted after the user enters a secret password without any further or external confirmation. Records stored in this database are, therefore, as secure as those managed by a software-only password manager, since their security ultimately hinges on the privacy of the secret password and on the security of the application itself.

### X. Exemplary Overview of Memory and Processing By Host Device, Security Device and Cloud Server Systems

In exemplary embodiments, the following databases can be used on host device 200 in coordination with security device 100:

(1) A first database is stored on the host running the password manager software. This database is kept permanently encrypted while the application is executed, but the database records and their keys can be accessed and individually decrypted after the user enters a secret password without any further or external confirmation. Records stored in this database are, therefore, as secure as those managed by any typical software-only password manager, since their security ultimately hinges on the privacy of the secret password and on the security of the application itself.

(2) A second database, is also stored on the host running the password manager software. This database is kept permanently encrypted while the application is executed, and it contains data related to records which can be accessed and individually decrypted only after the user confirms via physical action on the hardware device. This database stores the record's encrypted data, but none of the keys required to individually decrypt them. It will be possible to decrypt and view information from these records under two operational conditions: the hardware device is connected (over Bluetooth, USB, etc.) to the application which is requesting to view the record's data and the User has confirmed the request by physical action on the device (e.g. by swiping his finger). Optionally, the application can be authenticated by the device, such as for example found in U.S. Pat. No. 8,713,705B2, incorporated by reference herein in its entirety.

(3) A third database is stored on the hardware device and contains all records and their encryption keys. This database is kept permanently encrypted using keys which are never shared with any other system, for example non-extractable key(s) stored on a secure micro-controller or similar secure storage. Before sharing any record data with the client application, the data are encrypted/decrypted as needed on the device and securely sent to the application. This database is effectively the union of the first, second and fifth database described below, and is the “master copy” of all private information stored by the user. It is the sole and unique synchronization source across all computing hosts accessed by the user.

(4) A fourth database that can be stored on any storage medium connected to the host running the application. This database contains information and data for all private records and is a backup database kept permanently encrypted with a key derived from a complex backup password created during the initial system configuration and stored on the third database, for example. This database is updated with the data from the third database each time the client application is executed while connected to the device and is never decrypted by the application during standard usage: it is reserved, for example, only for restore purposes in the case of partial or catastrophic data loss from the third database or in order to restore all data on a new or additional hardware device.

(5) A fifth database containing all or part of the encryption keys of the records stored in the second database. The keys are kept individually permanently encrypted and can be provided one at a time to the client application as will be described below.

### XI. Exemplary Implementation of Memory and Processing By Host Device, Security Device and Cloud Server Systems

The aforementioned is further explained as follows. In an exemplary embodiment, database 202 is stored on host 200 running password manager software 201. Here, database 202 keeps encrypted data while the application is executed. The encryption key is kept on security device 100, particularly in memory locations 102-105. In the exemplary embodiment, security device 100 runs low level instructions such as assembler language embedded in firmware. In this and numerous other embodiments, device 100 lacks an open operating system, but instead runs the low level instructions in response to certain input received over a secure transaction. As device 100 is closed from non-authenticated communications, and purposefully does not include a generic operating system, it provides a very secure environment for maintaining the encryption key. Encryption keys for individual records are transmitted from device 100 back to host 200 when the user actuates device 100, by either actuating device 115, or providing required biometric or user-associated input via expanded input module 106.

In another exemplary embodiment, database 204 is stored on host 200 running password manager software 201. Here, database 204 keeps only fields associated with encrypted data. Both the encrypted data associated with the fields, as well as the encryption keys pertaining to each of the respective encrypted data, are kept in security device 100. In particular, device 100 keeps the encrypted data in memory locations 108, and the encryption keys in memory locations 102-105. In this embodiment, again device 100 is a closed system running low level instructions as above noted, except that both encryption keys and encrypted individual records of data corresponding to the fields of database 204, are maintained on the device. Again, actuation by the user via actuating device 115 or expanded input module 106 is required before the data records are encrypted by the encryption keys. In response to the user actuation, the unencrypted data is transmitted over secure connection 130 back to host device 200.

In another exemplary embodiment, database 205 is stored on host 200 running password manager software 201. Here, database 205 keeps a combination of some fields associated with encrypted data as well as some encrypted data, itself. Here, encrypted data associated with the one or more of the fields, encryption keys for such encrypted data of the fields, as well as encryption keys for encrypted data in database 205 are kept on security device 100. In particular, on device 100 the encrypted data are located in memory locations 108, and the encryption keys are located in memory locations 102-105. In this embodiment, again device 100 is a closed system running low level instructions as above noted, except that both encryption keys and encrypted individual records of data corresponding to the fields of database 204, are maintained on the device. Again, actuation by the user via actuating device 115 or expanded input module 106 is required before the data records are encrypted by the encryption keys. In response to the user actuation, for the data for which only fields are stored in database 205, the encrypted data is unencrypted via encryption keys, and transmitted back to host device 200 over a secure connection. In addition, in response to the user actuation, for data for which the encrypted data itself is kept in database 205, the respective encryption keys required are transmitted back to host device 200 over a secure connection, where the data is then unencrypted.

In exemplary implementations, rather than using particular memory locations for encrypted data, fields associated with encrypted data and/or encryption keys, the memory locations can be partitioned for the type of data held and marked accordingly. For example, in the exemplary embodiment of FIG. 6, the memory locations of host device 200 and accessed by client application 201 are designated as “boxed” records 206 and “unboxed” records 207. The boxed records are data which are explicitly marked as such, which include encrypted data stored locally on device 200, and for which encryption keys are kept on the security device 100. The unboxed records are data which are explicitly marked as such, which include encrypted data stored locally on device 200, and for which encryption keys are kept on host device 100 itself. In an exemplary embodiments, boxed data may be transformed by the user's actions to unboxed, and vice versa, as the encryption keys are respectively provided from device 100, or transmitted to device 100, and the memory locations are re-designated appropriately.

In exemplary embodiments, any particular one or any combination of the aforementioned features and functions of device 100, including of its respective component program code 101, data collections 102-108 and processor(s), are specifically carried out by one or more remote devices, such as remotely operated servers, in cloud 300. In particular, in exemplary embodiments, encryption keys are stored in memory locations 302-308 and/or encrypted and/or unencrypted data are stored in additional memory locations (not shown). In one particular exemplary embodiment, no user actuation (analogous to actuation of actuator device 112) is required for encrypted or unencrypted data, or encryption keys in encrypted or unencrypted format, to be transmitted to host device 200. In certain such exemplary embodiments, the processors of cloud 300 are (1) in closed systems, running for example low level instructions with limited, secure connections to other devices as above note with respect to device 100, while in other exemplary embodiments, (2) the processors of cloud 300 are in open systems, running on defined operating systems and with multiple inputs/outputs over open network connections that are not necessarily secure, while in yet additional embodiments, (3) the processors of cloud 300 run in environments that are a combination of the foregoing (1) closed systems and (2) open systems.

In exemplary embodiments, additional authentication is also used in addition to the above processes, both individually and in combined fashion. An exemplary additional authentication method is an out-of-band authentication of the user. Another exemplary authentication method employs dynamic authentication of a user pursuant to U.S. Pat. No. 8,713,705, entitled “Application Authentication System and Method,” and of common inventorship and assignee as the present embodiments, which is incorporated herein by reference in its entirety.

### XII. Exemplary System High Level Architecture

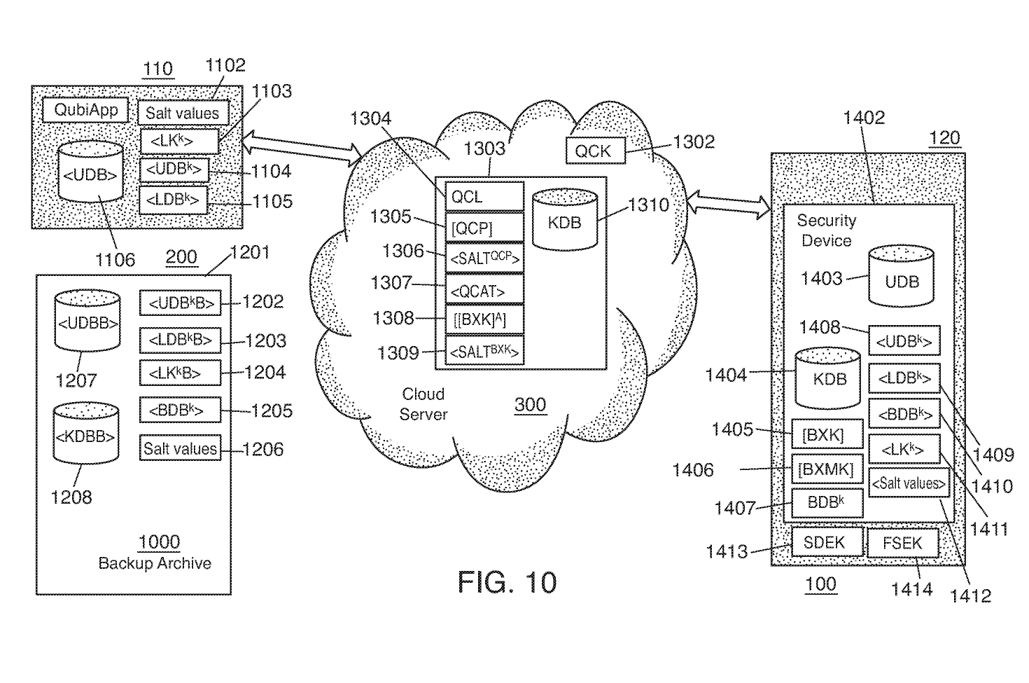

FIG. 10 illustrates a high level architecture of an exemplary implementation of the foregoing inventive concepts as used by EISST Ltd. of the United Kingdom in its Qubi product series. In the illustrated embodiment, host device 200 is running an app instance, and communicatively coupled to cloud server 300 and security device 100. In addition, a backup archive 1000 serves to provide archival functionality for host device 100.

The terminology employed in relation to FIG. 10 is detailed in the tables provided below. In particular, the tables are defined as follows. Table 1 provides a resource dictionary for databases and encryption employed; Table 2 provides a glossary of symbols defining exemplary encryption operations; Table 3 provides definitions of the databases used respectively for records (boxed and unboxed), encryption keys and for the backup archives; and Table 4 provides exemplary encryption technologies employed.

Beginning with host (QubiApp) device 200, included are: 1101—QubiApp instance; 1102—Salt values—four generated salt values; 1103—<LKK>-LKK encrypted with [BXK]LK; 1104—<UDBK>-UDBK encrypted with [BXK]UD; 1105—<LDBK>-LDBK encrypted with [BXK]LD; and 1106—<UDB>-UDB encrypted with UDBK.

Backup archive 1000 includes: 1201—QubiPass backup archive; 1202—<UDBKB>-<UDBK> encrypted with BDBK; 1203—<LDBKB>-<LDBK> encrypted with BDBK; 1204—<LKKB>-<LKK> encrypted with BDBK; 1205—<BDBKB>-BDBK encrypted with BXMK hashed with SALTBDB; 1206—Salt values—Backup copy of four generated salt values, plus SALTBDB; 1207—<UDBB>—Copy of <UDB>, and 1208—<KDBB>—Collection of <LK> encrypted with BDBK.

Cloud server (QubiCloud) 300 includes: 1302—QCK—QubiCloud key/salt encryption key; 1303—QCDB—QubiCloud Database; 1304—QCL—QubiCloud user login; 1305—[QCP]—QubiCloud user password hashed with SALTQCP; 1306—<SALTQCP>-SALTQCP encrypted with QCK; 1307—<QCAT>-QCAT encrypted with QCK; 1308—[[BXK]A]—[BXK]A hashed with SALTBXK; 1309—<SALTBXK>-SALTBXK encrypted with QCK; and 1310—KDB—Collection of <LK>.

Security (QubiBox) device 100 includes: 1402—Encrypted file system; 1403—UDB—Copy of UDB; 1404—KDB—Collection of <LK>; 1405—[BXK]—Hashed BXK; 1406—[BXMK]—Hashed BXMK; 1407—BDBk—Backup encryption key; 1408—<UDBK>—Copy of <UDBK>; 1409—<LDBK>—Copy of <LDBK>; 1410—<BDBK>-BDBK encrypted with BXMK hashed with SALTBDB; 1411—<LKKB>—Copy of <LKK>; 1412—Salt values—Copy of four generated salt values, plus SALTBDB; 1413—SDEK—Storage Encryption Key; and 1414—FSEK—File system encryption key.

TABLE 1

| Term | Definition |
|---|---|
| QubiPass or QP | The bundled QubiApp + QubiBox product |
| QubiApp or QA | QubiPass Manager (the software client component of |
| Application or App | the QubiPass product) |
| QubiCloud or QC | The cloud key escrow service provided to Users who |
| | wish to view Boxed records in disconnected mode. |
| BoxKey or BXK | The password required to run the QubiApp in both |
| | connected and disconnected modes |
| BoxMasterkey or | The password required for special operations, such as |
| BXMK | unblocking a QubiBox and recovering data from a |
| | backup archive. This password is used to backup |
| | (wrap) all the Records in encrypted format by the |
| | Application. The BoxMasterkey is defined once by |
| | the User and can be changed through the QubiApp |
| | Settings. |
| UDB (Unified | Database of unboxed records with their keys and |
| Database) | Boxed Records without keys kept on the host |
| KDB (Keys | Database of keys for decrypting the boxed records |
| Database) | |
| BDB (Backup | Archive with all the data required for a full restore |
| Archive) | |
| LK | Key which is used to encrypt a Boxed record, unique |
| | for each record |
| UK | Key which is used to encrypt an Unboxed record, |
| | unique for each record |
| UDB-K | Key which is used to encrypt the UDB |
| LDB-K | Key which is reserved for future use |
| BDB-K | Key which is used to encrypt the BDB |
| LK-K | Key which is used to encrypt the LK and UK |
| [BXK]-LK | Derivative of BXK which is used to encrypt LK-K |
| [BXK]-LD | Derivative of BXK which is used to encrypt LDB-K |
| [BXK]-UD | Derivative of BXK which is used to encrypt UDB-K |
| [BXMK]-BD | Derivate of BXMK which is used to encrypt BDB-K |
| QCK | QubiCloud key/salt encryption key, generated once |
| | during the deployment, stored outside QCDB |
| QCL | QubiCloud user login |
| QCDB | QubiCloud Database |
| QCP | QubiCloud user password |
| SYNCK | Randomly generated 256-bit AES key, used to |
| | encrypt KDB wholly or partially before transferring it |
| | to QubiCloud. Protects the contents of KDB from |
| | QubiApp |
| QCPuK | Public component of QCPK |
| QCAT | Randomly generated 128-bit Authorization Token |
| | issued to QubiApp by QubiCloud after authenticating |
| | the user |
| QCPK | QubiCloud's 2048-bit RSA private key |

TABLE 2

| Encryption Notation | Definition |
|---|---|
| < > | Encrypted quantities are indicated by enclosing the |
| | quantity within brackets, e.g. <Key> |
| [ ] | Hashed quantities are indicated by enclosing the |
| | quantity within square parenthesis, e.g. [Key] |
| ⊙ | Symmetric encryption (decryption) operation is |
| | indicated by the ⊙ symbol followed by the encryption |
| | (decryption) key, e.g. Key ⊙ [Key] → <Key> |
| -U | Quantities with a -U appended to the right indicate |
| | entries from the User |
| ≡ | Comparison operation is indicated by the ≡ symbol |
| | between two quantities |

TABLE 3

| Database | Definition |
|---|---|
| UDB (Unified | Database of unboxed records with their keys and |
| Database) | Boxed Records without keys kept on the host |
| KDB (Keys Database) | Database of keys for decrypting the boxed records |
| BDB (Backup | Archive with all the data required for a full restore |
| Archive) | |

TABLE 4

| Encryption | Definition |
|---|---|
| Cryptographically | A pseudo-random number generator designed to be |
| Secure Pseudo- | cryptographically secure, providing a high level of |
| Random Number | randomness and being completely unpredictable (see |
| Generator or | for example: |
| CSPRNG | http://en.wikipedia.org/wilci/CryptGenRandom) |
| SHA-256 | Secure hash function computed with a 32-bit words |
| | (http://en.wikipedia.org/wiki/SHA-2) |
| RIPEMD-256 | RACE Integrity Primitives Evaluation Message |
| | Digest (http://en.wikipedia.org/wiki/RIPEMD) |
| PBKDF2 | Password-Based Key Derivation Function 2 |
| | (http://en.wikipedia.org/wiki/PBKDF2) |
| Salt | Random data used as an additional input to a one-way |
| | hashing function that “hashes” the password or |
| | passphrase |

### XIII. Exemplary Setup and Configuration for QubiApp, QubiBox and QubiCloud

The setup and configuration of QubiApp, QubiBox and QubiCloud may be in accordance with the following exemplary embodiment.

1. The User is asked to choose a BoxKey (BXK) with given complexity requirements.

2. If the Host is already set up in Disconnected mode, check if the given BXK can be used to decrypt existing <UDBK>. If not, require the User to enter valid BXK or ask if the existing keys and databases can be removed.

3. The User is asked to choose a BoxMasterkey (BXMK) with given complexity requirements.

4. QubiApp generates three random AES256 encryption keys: UDBK, LDBK, LKK

5. QubiApp generates four fixed-length random salt values. The length of the salt values must be 128 bits.

6. QubiApp generates four salted consecutive hashes from BXK in the following order: [BXK]LK→[BXK]LD→[BXK]UD→[BXK]A. The salt value must be stored on the Host and the Device with the respective key encryption key, encrypted with BXK, for future uses.

7. Use the hashes derived from BXK as key encryption keys: UDBK ⊙ [BXK]UD→<UDBK>LDBK ⊙ [BXK]LD→<LDBK >LKK ⊙ [BXK]LK→<LKK>

8. Create UDB, the database for storing Records and their encryption keys (if it doesn't exist)

9. Store <UDB>, <UDBK>, <LDBK> and <LKK> on the Host

10. QubiApp initiates QubiBox personalization by sending BXMK as PUK

11. QubiBox generates embedded file system encryption key: FSEK

12. QubiBox formats the embedded file system using FSEK

13. QubiBox reads Storage Encryption Key from the protected memory: SDEK

14. QubiBox encrypts FSEK with SDEK: FSEK ⊙ SDEK→<FSEK>

15. QubiBox stores <FSEK> on the embedded file system header

16. QubiBox opens the embedded file system using FSEK

17. QubiBox hashes BXMK: [BXMK]

18. QubiBox stores [BXMK] on the embedded file system and marks it as non-exportable

19. QubiBox generates 128-bit random salt value on the device: SALTBDB

20. QubiBox generates a salted hash from BXMK with SALT^{BDB} with 2000 iterations: [BXMK]^{BD}

21. QubiBox generates a random AES256 encryption key: BD^{BK}

22. QubiBox stores BD^{BK} on the embedded file system and marks it as non-exportable

23. QubiBox stores SALT^{BDB} on the embedded file system and marks it as exportable

24. QubiBox encrypts BDB^{K}: BDB^{K} ⊙ [BXMK]^{BD}→<BDB^{K}>

25. QubiBox stores <BDB^{K}> on the embedded file system and marks it as exportable

26. QubiApp logs into QubiBox with BXMK as PUK

27. QubiApp sends BXK to QubiBox as PIN

28. QubiBox hashes BXK: [BXK]

29. QubiBox stores [BXK] on the embedded file system and marks it as non-exportable

30. The User logs into QubiApp (see 3.4 or 3.5 of QubiApp Key & DB Management)

31. QubiApp reads QCAT from UDB

32. QubiApp sends QCAT, [BXK- [symbol] ]^{A} and the device serial number to QubiCloud

33. QubiCloud verifies if QCAT is valid with QCDB

34. QubiCloud stores the device serial number in the QCDB

35. QubiCloud generates a 128-bit salt for hashing the [BXK]^{A} and stores it in the QCDB: SALT^{BXK}

36. QubiCloud generates a salted hash from [BXK]^{A} and SALT^{BXK}: [[BXK]^{A}]

37. QubiCloud stores [[BXK]^{A}] in the QCDB

38. Clear all setup and initialization objects from process memory of the Host

### XIII. Certain Computer Implementation of the Embodiments

As also will be appreciated by one skilled in the art, the various functional aspects of the embodiments can be provided with numerous technologies. Accordingly, the embodiments can take the form of an entirely hardware embodiment or an embodiment combining hardware and software aspects. Further, the embodiments can take the form of a non-transitory computer program product stored on a computer-readable storage medium having computer-readable instructions embodied in the medium. Any suitable computer-readable medium can be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable, volatile/nonvolatile, and transitory/non-transitory computer storage media. For example, the processor can access a hard disk drive that reads from or writes to non-removable, nonvolatile, and non-transitory magnetic media, a magnetic disk drive that reads from or writes to a removable, nonvolatile, and non-transitory magnetic disk, and/or an optical disk drive that reads from or writes to a removable, nonvolatile, and non-transitory optical disk, such as a CD-ROM or other optical media. Other removable/non-removable, volatile/nonvolatile, and non-transitory computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

### XIV. Certain Computer Implementation of the Embodiments

It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments can be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All patents and applications and publications discussed above are hereby incorporated herein by reference in their entireties.

What is claimed is:

1. A system for protecting the privacy associated with one or more encrypted data records, the system comprising:
a host device operable to allow access to the one or more data records being in an encrypted format comprising encrypted data records, and upon an attempt to access the one or more encrypted data records transmitting a request for an encryption key for unencrypting the encrypted data records to a security device; and
a security device remote from the host device operable to require one or more actions being taken by a user as a condition to providing said encryption key, and upon the success of said actions as said condition, transmitting said encryption key to the host device.

2. The system of claim 1, wherein the host device unlocks said one or more encrypted data records upon receipt of said encryption key.

3. The system of claim 1, wherein the one or more encrypted data records are resident on the host device.

4. The system of claim 1, wherein one or more fields associated with each of the one or more encrypted data records are maintained on the host device, and the one or more encrypted data records associated therewith are resident on the security device.

5. The system of claim 1, wherein the host device and security device are securely coupled over a telecommunications connection, said connection being any one of a wireline and a wireless connection.

6. The system of claim 5, wherein the security device comprises a system closed from external communications but in relation to said encrypted data records and one or more additional encrypted data records, and further is operable to execute low level instructions in an embedded, secured processing system.

7. The system of claim 1, wherein the host device comprises one or more software applications resident and executing on any one of: a personal computer; a tablet; a smart watch; and a mobile communications device.

8. The system of claim 1, wherein the one or more actions comprise any one of: physical actuation by a user; entry of information by the user; and entry of biometric information by the user.

9. The system of claim 1, further comprising a remote processing device accessible over the Internet, said remote processing device (a) able to access said encryption key, (b) being operable to require one or more items of information provided by a user as a condition to providing said encryption key, and (c) upon determining said items of information to be correct information, transmitting said encryption key to the host device.

10. The system of claim 1, further comprising any one of: an out-of-band authentication of a user; and a dynamic authentication of a user upon the processing of one or more signals between the host device and the security device.

11. The system of claim 1, wherein the host device is further operable to maintain the encryption key and to mark the encrypted data records to reflect that said encryption key is being maintained on said host device.

12. A method for protecting the privacy associated with one or more encrypted data records accessible by a host device, the method comprising:
maintaining an encryption key for unencrypting the one or more records on a security device;
upon an attempt to access the one or more encrypted records, transmitting a request for said encryption key to the security device; and
requiring one or more actions to be taken in relation to the security device as a condition to providing said encryption key to the host device.

13. The method of claim 12, further comprising: decrypting the one or more encrypted records of the host device upon receipt of the encryption key.

14. The method of claim 12, wherein the one or more encrypted data records are maintained resident on the host device.

15. The method of claim 12, wherein one or more fields associated with each of the one or more records are maintained on the host device, and the one or more encrypted data records are maintained resident on the security device.

16. The method of claim 12, further comprising securely coupling over a telecommunications connection the host device and security device, said connection being any one of a wireline and a wireless connection.

17. The method of claim 16, wherein low level instructions are executed in an embedded, secured processing system on the security device.

18. The method of claim 1, further comprising: maintaining the encryption key on a remote processing device accessible over the Internet, and upon an attempt to access the one or more encrypted records, requiring one or more items of information being provided by a user as a condition to providing the encryption key from said remote processing device.

19. The method of claim 1, wherein the one or more actions comprise any one of: physical actuation by a user; entry of information by the user; and entry of biometric information by the user.

20. The method of claim 1, further comprising any one of: an out-of-band authentication of a user; and a dynamic authentication of a user upon the processing of one or more signals between the host device and the security device.

21. A method for protecting the privacy associated with one or more encrypted data records accessible, the method comprising:
maintaining the encrypted data records resident on a device, the encrypted data records being operable to become unencrypted upon actuation of a unique encryption key;
upon an attempt to access the one or more encrypted records, transmitting a request for the encryption key; and
upon user action being taken remotely, actuating a received key comprising said unique encryption key to unencrypt the encrypted data records.

22. A method for protecting the privacy associated with one or more encrypted data records accessible, the method comprising:
maintaining a unique encryption key operable to unlock one or more encrypted data records, said encrypted data records being remote from a device; and
upon actuation by a user, transmitting the encryption key to the remote device in order to permit unlocking of said one or more data records.
